(19) United States
(12) Patent Application Publication
(10) Pub. No.: US 2005/0247256 A1
(43) Pub. Date: Nov. 10, 2005

(54) Flag mounting arrangement

(76) Inventor: Brian J. Larson, Tucson, AZ (US)

Correspondence Address: QUARLES & BRADY STREICH LANG, LLP, ONE SOUTH CHURCH AVENUE, SUITE 1700, TUCSON, AZ, 85701-1621, US

(21) Appl. No.: 10/841,099

(22) Filed: May 7, 2004

(51) Int. Cl. G09F 17/00

(52) U.S. Cl. 116/173

(57) ABSTRACT

An arrangement for mounting a flag includes a flagpole and a tubular member which is connectable to the flagpole. The tubular member has a passage which can receive the flagpole, and the tubular member and flagpole are designed such that the connection between the tubular member and the flagpole is located internally of the passage. The tubular member has slits which allow the connection to be established and broken from externally of the tubular member. The tubular member serves as a holder for the flag and is provided with a second passage which can slidably receive the flag.

### BACKGROUND OF THE INVENTION

1. Field of the Invention

The invention relates to an arrangement for mounting a flag.

2. Description of the Prior Art

The flag marking the location of the cup on the green of a golf course is typically mounted on a pole which is designed to be placed in the cup. The flag sits at one end of the pole and this end of the pole has a threaded portion of smaller diameter than the remaining, main portion of the pole. Hence, the threaded portion and the main portion of the pole define a shoulder.

A polyvinylchloride tube having a flange which runs the length of the tube is used to mount the flag on the flagpole. The flag is rectangular and the length of the tube and the flange approximates the length of the shorter sides of the flag. One of the shorter margins of the flag is wrapped around the tube and the flange and is stitched to the flange.

The tube and the flagpole have circular cross sections and the inner diameter of the tube exceeds the outer diameter of the main portion of the flagpole so that the flagpole can be inserted in the tube. A ring is formed at one end of the tube and is provided with a circular opening whose diameter is greater than that of the threaded portion of the flagpole but smaller than that of the main portion of the flagpole. To attach the tube to the flagpole, the threaded portion of the flagpole is passed through the opening in the ring and the shoulder defined by the main portion and the threaded portion of the flagpole is brought into abutment with the ring. The threaded portion of the flagpole then projects from the tube and a nut is screwed onto the threaded portion to secure the flagpole to the tube.

### SUMMARY OF THE INVENTION

One aspect of the invention resides in a flag mounting arrangement comprising an elongated supporting member and a carrying member designed to hold a flag and to be supported by the supporting member. The carrying member is provided with a passage designed to receive the supporting member.

One embodiment of the flag mounting arrangement, further comprises means for connecting the supporting member to the carrying member, and the connecting means includes a first connecting element in the passage of the carrying member and a second connecting element for engagement with and disengagement from the supporting member. The connecting means, the supporting member and the carrying member are designed so that the second connecting element is recessed in the passage of the carrying member at a predetermined location of the passage when the connecting means connects the supporting member to the carrying member.

In an additional embodiment of the flag mounting arrangement, the carrying member is provided with a second passage for holding a flag.

Another aspect of the invention resides in a flag mounting arrangement comprising a flag and a carrying member for holding the flag. The flag includes a layer of polyvinylchloride.

An additional aspect of the invention resides in a flag mounting method comprising the steps of providing a supporting member and providing a carrying member. The carrying member, which has a passage, is designed to hold a flag and to be supported by the supporting member. The method further comprises the step of inserting the supporting member in the passage of the carrying member.

One embodiment of the method additionally comprises the step of connecting the supporting member to the carrying member, and the connecting step includes engaging a connecting element with the supporting member inside the passage of the carrying member.

The passage in the carrying member may have an open end and the supporting member can be inserted in the passage via such open end. The present embodiment of the method can here comprise a further step of inhibiting contact between the supporting member and the carrying member in the region of the open end of the passage.

Another embodiment of the flag mounting method comprises the steps of providing a flag and mounting the flag on the carrying member. The carrying member can be provided with a second passage and the mounting step may then include inserting a selected portion of the flag in the second passage.

This embodiment of the flag mounting method can comprise the additional step of providing a carrier and, in such an event, the mounting step may involve at least partially enclosing the carrier with the selected portion of the flag prior to inserting the selected portion of the flag in the second passage of the carrying member.

A further aspect of the invention resides in a flag mounting method comprising the steps of providing a flag, providing a carrying member designed to hold flag and mounting the flag on the carrying member. The flag here includes a layer of polyvinylchloride.

The flag can include another layer of polyester which is preferably in the form of a mesh. Moreover, the flag may be provided with a laser-printed image.

Additional features and advantages of the invention will be forthcoming from the following detailed description of certain preferred embodiments when read in conjunction with the accompanying drawings.

### BRIEF DESCRIPTION OF THE DRAWINGS

FIG. 1 is a plan view of a flag which is designed in accordance with the invention and is folded around a stiffener for the flag.

FIG. 2 is an enlarged sectional view of the flag and the stiffener in the direction of the arrows II-II of FIG. 1.

FIG. 3 is a side view of the stiffener of FIG. 1.

FIG. 4 is an end view of the stiffener of FIG. 1.

FIG. 5 is a side view of a flagpole for the flag of FIG. 1 and of a nut which screws onto a threaded shaft forming part of the flagpole.

FIG. 6 is a perspective view of a holding member which is designed to hold the flag of FIG. 1 and to be mounted on the flagpole of FIG. 5.

FIG. 7 is a sectional view of the holding member, with wall thicknesses exaggerated, as seen in the direction of the arrows VII-VII of FIG. 6.

FIG. 8 is an end view of the holding member as seen in the direction of the arrow VIII of FIG. 6.

FIG. 9 is an end view of the holding member as seen in the direction of the arrow IX of FIG. 6.

FIG. 10 is a plan view of a tool for use in screwing the nut of FIG. 5 onto the threaded shaft of the flagpole of FIG. 5.

FIG. 11 is a side view of the tool of FIG. 10.

### DESCRIPTION OF THE PREFERRED EMBODIMENTS

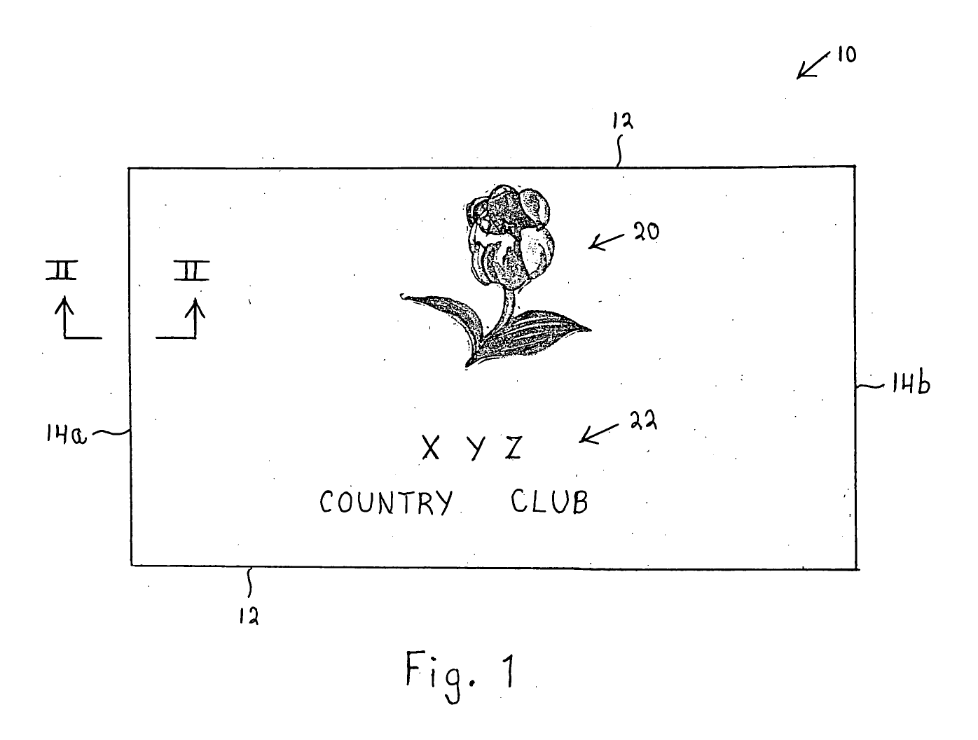

Referring to FIG. 1, the numeral 10 identifies a flag in accordance with the invention. The flag 10 is rectangular and has two longer margins or marginal portions 12 and two shorter margins or marginal portions 14a and 14b. The flag 10, which could have a shape other than rectangular, is here assumed to belong to a golfing facility which utilizes the flag 10 to mark the location of a cup on the green of a golf course.

Considering FIG. 2 in conjunction with FIG. 1, the flag 10 includes a base or base layer 16 of polyester mesh and a coating or additional layer 18 of polyvinylchloride. The coating 18 is provided with markings including an image 20 which represents a flower and a legend 22 identifying the golfing facility which owns the flag 10. Other markings could be provided on the flag 10 in lieu of or in addition to the image 20 and the legend 22.

The polyester mesh of the base 16 allows the flag 10 to be lightweight while the polyvinylchloride coating 18 permits markings to be laser-printed on the flag 10. Both the image 20 and the legend 22 have been laser-printed on the coating 18.

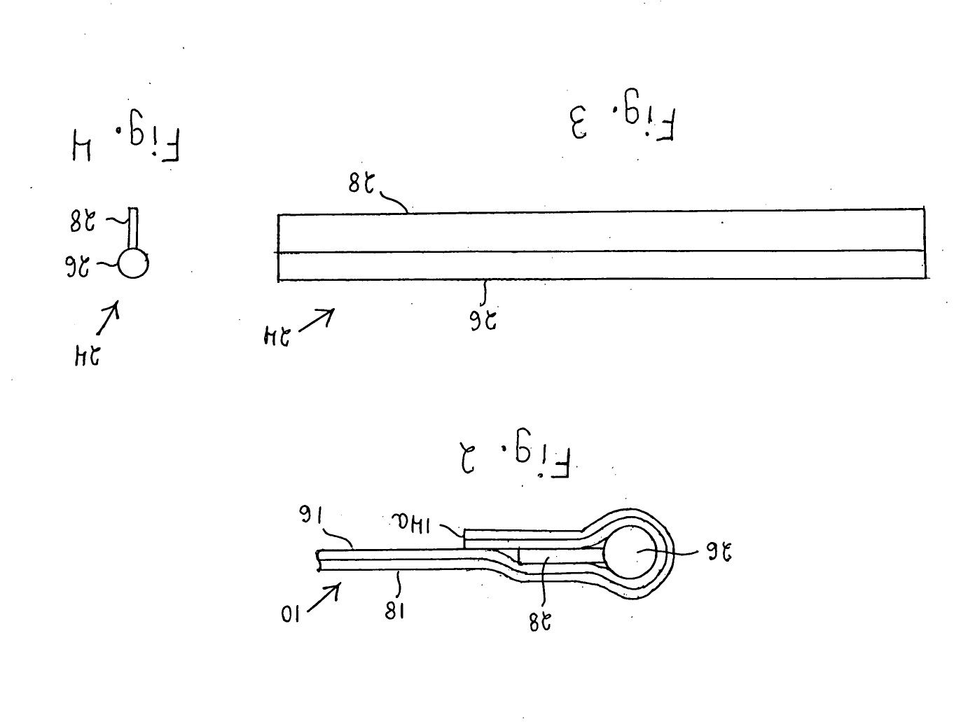

Turning to FIGS. 3 and 4 together with FIG. 2, the shorter margin 14a of the flag 10 is wrapped around a stiffener or carrier 24 for the flag 10, and the shorter margin 14a completely or almost completely encloses the stiffener 24. The stiffener 24 includes a spine or elongated component 26 which is here in the form of a rod or bar of circular cross section. The stiffener 24 further includes a flange 28 constituted by a flat strip which runs the length of the spine 26. The flange 28 is coplanar with the longitudinal axis of the spine 26 and the longitudinal edges of the flange 28 are parallel to the longitudinal axis of the spine 26. One of the longitudinal edges of the flange 28 is bonded to the peripheral surface of the spine 26. The length of the spine 26 and the flange 28 is equal to or somewhat less than the length of the shorter margins 14a, 14b of the flag 10.

The stiffener 24 can, for example, consist of polyvinylchloride.

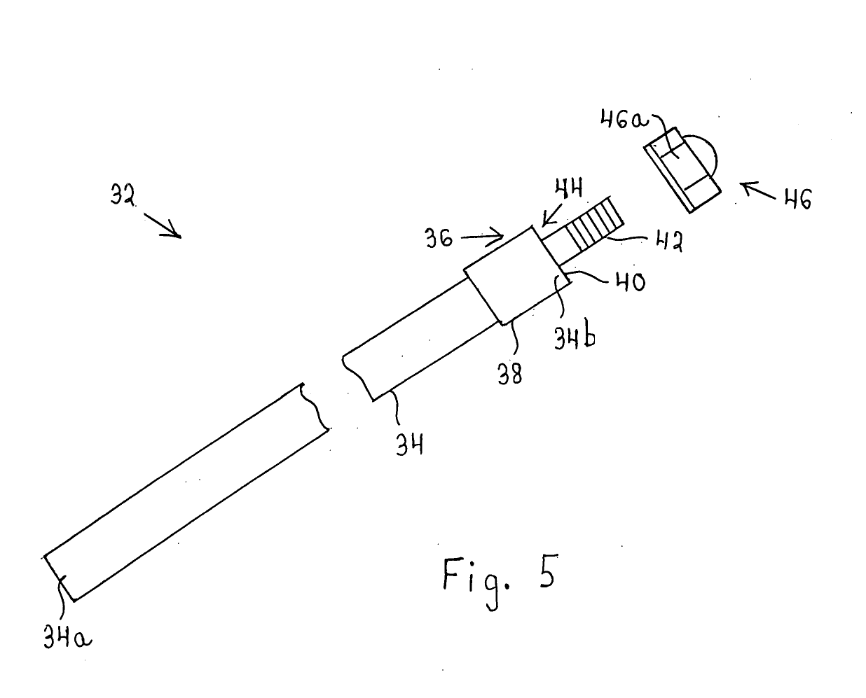

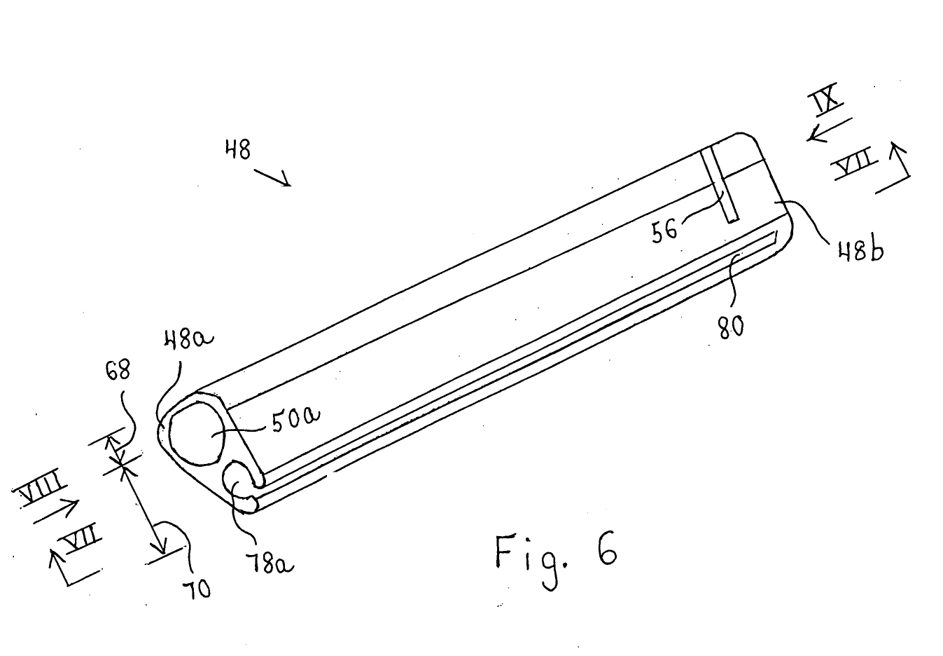

Referring to FIG. 5, the numeral 32 identifies an elongated supporting member for holding the flag 10 aloft. The elongated supporting member 32 is here a flagpole of the type commonly used on a golf course to hold up a flag which marks the location of the cup on a green.

The flagpole 32 includes a main portion 34 constituted by a bar of circular cross section. The bar 34 has two ends 34a and 34b and a cap 36 is mounted on the end 34b. The cap 36 comprises a tubular element or portion 38 of circular cross section which receives the bar end 34b and a circular end wall 40 which closes one end of the tubular element 38 and covers the bar end 34b. The cap 36 further comprises a threaded shaft or portion 42 which projects from the end wall 40 and the bar end 34b axially of the bar 34. The threaded shaft 42 has a circular cross section, and the diameter of the threaded shaft 42 is smaller than the diameter of the end wall 40 and smaller than the diameter of the bar 34. Hence, the threaded shaft 42 and the end wall 40 define an annular shoulder 44 which runs circumferentially of the threaded shaft 42.

A nut or nut-like component 46 is designed to screw onto the threaded shaft 42. The nut 46 is here a cap nut having several pairs of facets 46a, and the facets 46a are arranged such that the facets 46a of each pair are diametrically opposed.

Considering FIGS. 6-9, the numeral 48 denotes a tubular carrying or holding member which is adapted to be supported by the flagpole 32. The tubular member 48 is elongated and has two ends 48a and 48b, and the length of the tubular member 48 exceeds the length of the shorter margins 14a, 14b of the flag 10. The tubular member 48 is provided with a passage 50 of circular cross section which runs longitudinally of the tubular member 48 from the end 48a to the end 48b. The passage 50 includes a section 50a of larger diameter which has an exposed open end at the end 48a of the tubular member 48 and a section 50b of smaller diameter which has an exposed open end at the end 48b of the tubular member 48. The diameters of both the larger-diameter passage section 50a and the smaller-diameter passage section 50b exceed the maximum diameter of the flagpole 32 and the maximum width of the cap nut 46. Thus, the passage 50 can receive both the flagpole 32 and the cap nut 46.

An annular abutment 52 having a central circular opening 54 is located inside the smaller-diameter passage section 50b nearer the end 48b than the end 48a of the tubular member 48. The abutment 52 and the central opening 54 have a common axis which coincides with the longitudinal axis of the flagpole passage 50. The diameter of the central opening 54 is greater than the diameter of the threaded shaft 42 of the flagpole 32 and smaller than the diameter of the annular shoulder 44 extending circumferentially of the threaded shaft 42. Accordingly, the threaded shaft 42 can pass through the central opening 54 while the cap 36 and the bar 34 of the flagpole 32 are unable to do so. The diameter of the central opening 54 is also smaller than the diameter of the cap nut 46 which screws onto the threaded shaft 42.

To mount the tubular member 48 on the flagpole 32, the flagpole 32 is inserted in the flagpole passage 50 through the end 48a of the tubular member 48. The flagpole 32 is introduced into the flagpole passage 50 with the threaded shaft 42 leading, and the threaded shaft 42 is passed through the central opening 54 of the abutment 52. The flagpole 32 is properly located in the flagpole passage 50 when the threaded shaft 42 is received in the central opening 54. Preferably, the abutment 52 is located at such a distance from the exposed open end of the smaller-diameter passage section 50b that the threaded shaft 42 does not project from the tubular member 48 even if the flagpole 32 is inserted into the flagpole passage 50 so far that the annular shoulder 44 running circumferentially of the threaded shaft 42 rests against the abutment 52. On the other hand, the bar 34 of the flagpole 32 projects from the tubular member 48 through the exposed open end of the larger-diameter passage section 50a when the flagpole 32 is properly situated in the flagpole passage 50. This allows the bar 34 to be planted in a cup on the green of a golf course.

To fix the flagpole 32 to the tubular member 48 once the flagpole 32 has been properly positioned in the flagpole passage 50, the cap nut 46 is screwed onto the threaded shaft 42 and tightened. However, since the smaller-diameter passage section 50b is, by design, too narrow to accommodate two fingers of a human hand simultaneously, tightening of the cap nut 46 is difficult or impossible to accomplish with the fingers if the threaded shaft 42 is recessed in the smaller-diameter passage section 50b as is preferred.

In order to allow the cap nut 46 to be tightened when the threaded shaft 42 is recessed in the smaller-diameter passage section 50b, the tubular member 48 is provided with two diametrically opposed, slits or elongated cutouts 56 (only one of the slits 56 is visible in the drawings). The slits 56 run transverse to the longitudinal axis of the flagpole passage 50 and, as considered longitudinally of the tubular member 48, are located adjacent to the abutment 52 between the latter and the exposed open end of the smaller-diameter passage section 50b. At least a portion of each slit 56 opens to the external peripheral surface of the tubular member 48 and to the smaller-diameter passage section 50b, and the width of each slit 56 is selected in such a manner that none of the fingers of a human hand can be inserted in the respective slit 56.

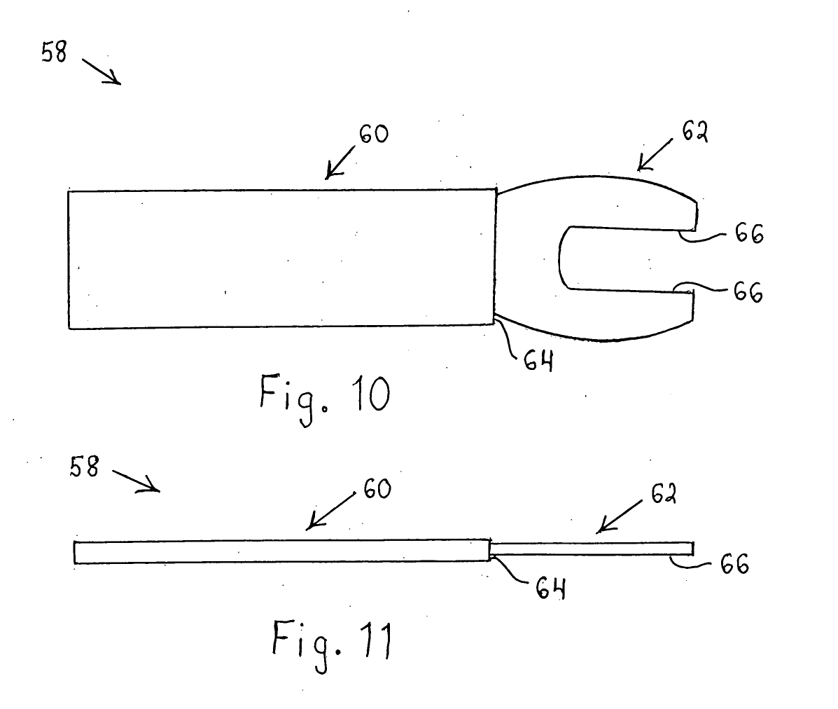

Turning to FIGS. 10 and 11, the numeral 58 identifies a tool or implement for tightening the cap nut 46 on the threaded shaft 42 of the flagpole 32 when the threaded shaft 42 is recessed in the smaller-diameter passage section 50b. The tool 58 is in the form of a wrench having a flat, elongated handle 60 and a flat gripping head 62 at one end of the handle 60. The handle 60 here includes a strip-like member enclosed in a plastic jacket 64 while the gripping head 62 includes a pair of spaced tines 66 which are located in a common plane and are parallel to the longitudinal axis of the wrench handle 60.

The thickness of the tines 66 is less than the width of the slits 56 in the tubular member 48 thereby permitting the tines 66 to enter the slits 56. The distance between the tines 66 is slightly greater than the distance between diametrically opposed facets 46a of the nut 46 so that the wrench 58 can hold the nut 46 against rotation relative to the tines 66 when the nut 46 is received between the tines 66 with two diametrically opposed facets 46a facing respective ones of the tines 66.

Referring to FIGS. 6, 8 and 9, the tubular member 48 has a semicircular portion 68 and an abutting tapering portion 70 as seen in a transverse cross section of the tubular member 48. The tapering portion 70 narrows in a direction away from the semicircular portion 68, and the tubular member 48 has a maximum width at the junction of the semicircular portion 68 and the tapering portion 70. The flagpole passage 50 extends from the semicircular portion 68 into an adjoining part of the tapering portion 70 and the slits 56 likewise run between the semicircular portion 68 and the tapering portion 70.

When the threaded shaft 42 of the flagpole 32 is inserted in the flagpole passage 50 and the cap nut 46 is to be screwed onto the threaded shaft 42, the cap nut 46 is introduced into the flagpole passage 50 and the wrench 58 is employed to hold the cap nut 46 against rotation. To this end, the tines 66 of the wrench 58 are slid into respective ones of the slits 56. The distance between the tines 66 is less than the diameter of the smaller-diameter passage section 50b so that the tines 66 project into the smaller-diameter passage section 50b and can hold the cap nut 46. Once the cap nut 46 has been captured by the tines 66, the flagpole 32 can rotated to screw the threaded shaft 42 into the cap nut 46.

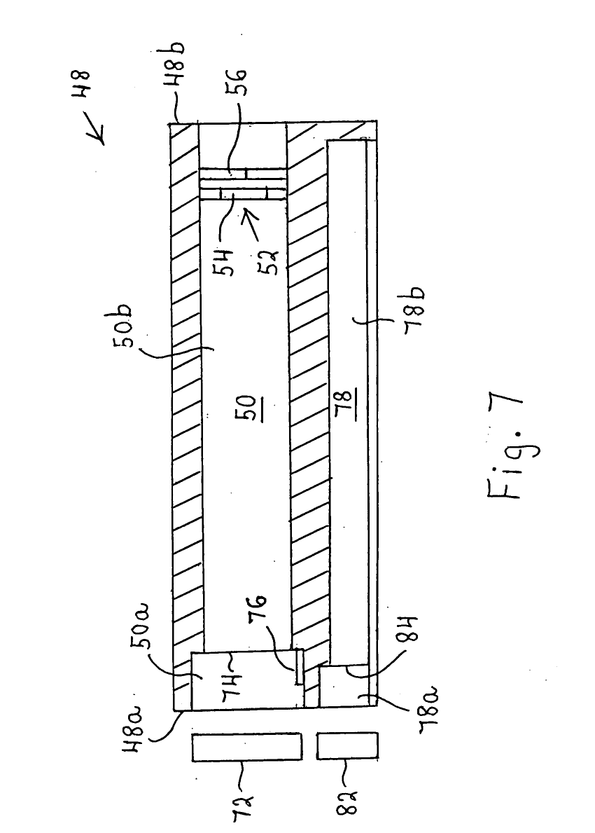

Considering FIG. 7, the numeral 72 identifies a ring or insert having an outer diameter larger than the diameter of the smaller-diameter passage section 50b and somewhat smaller than the diameter of the larger-diameter passage section 50a. The inner diameter of the ring 72 is somewhat larger than the diameter of the flagpole bar 34, and the ring 72 is designed to be inserted in the larger-diameter passage section 50a. The ring 72 is intended to reduce the play available for the bar 34 and to prevent the tubular member 48 from directly impacting, and possible being damaged by, the bar 34 when a force such as the wind causes the tubular member 48 and the bar 34 to move relative to one another.

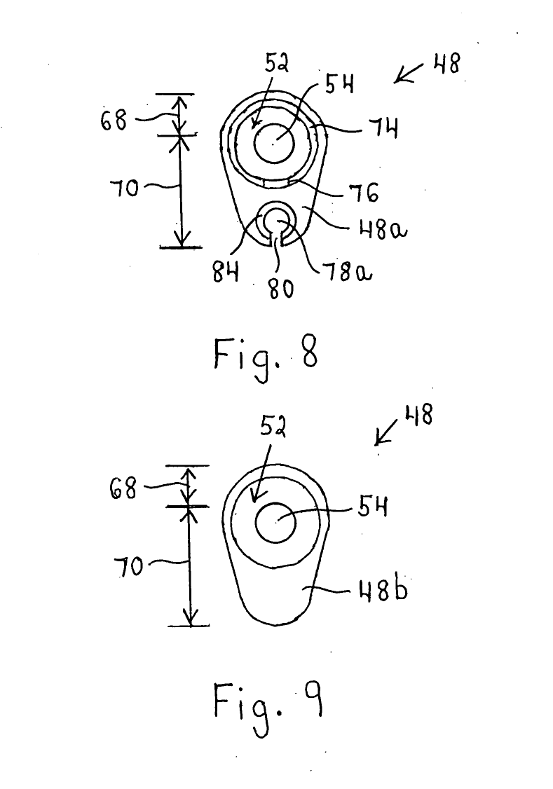

Turning to FIG. 8 together with FIG. 7, an annular seat 74 for the ring 72 is provided in the flagpole passage 50 at the junction of the larger-diameter passage section 50a and the smaller-diameter passage section 50b. Two ribs 76 in the larger-diameter passage section 50a run longitudinally of the tubular member 48 from the seat 74 partway to the exposed open end of the larger-diameter passage section 50a. The ribs 76, which have a minimal height, assure that the ring 72 fits snugly in the larger-diameter passage section 50a and will not fall out.

Referring to FIGS. 6, 7 and 8, the tubular member 48 is formed with an additional or second passage 78 of circular cross section which runs parallel to the flagpole passage 50 and is located in the tapering portion 70 of the tubular member 48. The additional passage 78 runs almost, but not quite, the length of the tubular member 48.

The additional passage 78 includes a section 78a of larger diameter which has an exposed open end at the end 48a of the tubular member 48 and a section 78b of smaller diameter which extends from the larger-diameter passage section 78a to a location just short of the end 48b of the tubular member 48.

A slot or slot-like opening 80 is formed in the narrowest part of the tapering portion 70 of the tubular member 48. The slot 80, which is parallel to the flagpole passage 50 and the additional passage 78 and runs the length of the additional passage 78, opens to the additional passage 78 and to the external peripheral surface of the tubular member 48. Like the additional passage 78, the slot 80 has an exposed open end at the end 48a of the tubular member 48 and a closed end near the end 48b of the tubular member 48.

The length of the additional passage 78 and the slot 80 exceeds the length of the shorter margins 14a,14b of the flag 10. The diameter of the smaller-diameter section 78b of the additional passage 78 is selected so that the spine 26 of the stiffener 24, when enclosed by the margin 14a of the flag 10, fits in the smaller-diameter passage section 78b with a small amount of play sufficient for the spine 26 and the margin 14a to be slidable in the smaller-diameter passage section 78b. Similarly, the width of the slot 80 is such that the flange 28 of the stiffener 24 can enter and slide along the slot 80 with a minimal amount of play when the margin 14a of the flag 10 is wrapped around the flange 28.

As seen in FIG. 7, a plug 82 of circular cross section is provided to close the exposed open end of the larger-diameter passage section 78a. The plug 82, which fits snugly in the larger-diameter passage section 78a, prevents the stiffener 24 and the flag 10 from falling out of or being easily removed from the additional passage 78 and the slot 80. If desired, the plug 82 can be bonded to the tubular member 48 after being inserted in the exposed open end of the additional passage 78.

An annular seat 54 for the plug 82 is provided in the additional passage 78 at the junction of the larger-diameter passage section 78a and the smaller-diameter passage section 78b.

The stiffener 24, the flagpole 32 and the tubular member 48 all constitute part of an arrangement for mounting the flag 10. One manner of assembling the flag mounting arrangement is as follows:

The margin 14a of the flag 10 is folded around the spine 26 and the flange 28 of the stiffener 24. The spine 26 is then aligned with the open end of the additional passage 78 of the tubular member 48 while the flange 28 is aligned with the open end of the slot 80. The spine 26 is thereupon inserted in the additional passage 78 whereas the flange 28 is inserted in the slot 80. The margin 14a of the flag 10 is held around the spine 26 and the flange 28 during insertion of the spine 26 and the flange 28 into the additional passage 78 and the slot 80.

After the spine 26 has been inserted in the additional passage 78 and the flange 28 has been inserted in the slot 80, the spine 26 is slid along the additional passage 78 to the closed end of the additional passage 78 while the flange 28 is slid along the slot 80 to the closed end of the slot 80. The margin 14a of the flag 10 continues to be held around the spine 26 and the flange 28 during movement of the spine 26 and the flange 28 along the additional passage 78 and the slot 80.

Once the spine 26 abuts the closed end of the additional passage 78 and the flange 28 abuts the closed end of the slot 80, a suitable adhesive is applied to the perimeter of the plug 82. The plug 82 is subsequently inserted in the exposed open end of the additional passage 78 and the adhesive is allowed to set.

The ring 72 is inserted in the exposed open end of the larger-diameter passage section 50a and pushed inward until the ring 72 lies against the seat 74 of the tubular member 48. The flagpole 32 is now introduced into the exposed open end of the larger-diameter passage section 50a with the threaded shaft 42 leading. The threaded shaft 42 is passed through ring 72 and the central opening 54 of the abutment 52, and the annular shoulder 44 of the flagpole 32 is brought to bear against the abutment 52. The cap nut 46 is thereupon screwed onto the threaded shaft 42.

It is here assumed that the flagpole 32 and the tubular member 48 are designed such that the threaded shaft 42 does not project from the smaller-diameter passage section 50b when the annular shoulder 44 of the flagpole 32 lies against the abutment 52, i.e., the entire length of the threaded shaft 42 is recessed in the smaller-diameter passage section 50b. Since, as mentioned earlier, the smaller-diameter passage section 50b is too narrow to accommodate two fingers of a human hand simultaneously, it is accordingly difficult to securely screw the cap nut 46 onto the threaded shaft 42 by hand.

In order to screw the cap nut 46 onto the threaded shaft 42, the cap nut 46 is placed on the threaded shaft 42 and held against rotation with a finger. The flagpole 32 is now rotated thereby causing the cap nut 46 to be screwed onto the threaded shaft 42. The cap nut 46 can be preliminarily tightened in this manner.

When the cap nut 46 has been preliminarily tightened on the threaded shaft 42, the cap nut 46 is brought into register with the slits 56 in the tubular member 48 by shifting the flagpole 32 so that the annular shoulder 44 of the flagpole 32 moves away from the abutment 52. The flagpole 32 and the tubular member 48 can be designed such that the cap nut 46 rests against the abutment 52 when the cap nut 46 registers with the slits 56. The cap nut 46 is positioned with two opposed facets 46a of the cap nut 46 facing respective ones of the slits 56, and the tines 66 of the wrench 58 are then inserted in the slits 56 in order to capture the cap nut 46 and hold the cap nut 46 against rotation. Once the cap nut 46 is held by the wrench 58, the flagpole 32 is once again rotated to firmly tighten the cap nut 46 on the threaded shaft 42. The flagpole 32 can now be placed in the cup of a green on a golf course.

After the cap nut 46 has been screwed onto the threaded shaft 42, the cap nut 46 remains recessed in the smaller-diameter passage section 50b regardless of the position of the threaded shaft 42 in the smaller-diameter passage section 50b.

To remove the cap nut 46 from the threaded shaft 42, the flagpole 32 is shifted, if necessary, to once more bring the cap nut 46 into register with the slits 56 in the tubular member 48. The cap nut 46 is again positioned with two opposed facets 46a of the cap nut 46 facing respective ones of the slits 56, and the tines 66 of the wrench 58 are thereupon inserted in the slits 56 to hold the cap nut 46 against rotation. The flagpole 32 is now rotated in the opposite sense from before until the cap nut 46 is released from the threaded shaft 42.

Recessing of the threaded shaft 42 and the cap nut 46 in the smaller-diameter passage section 50b makes it difficult to disconnect the tubular member 48 from the flagpole 32. This, in turn, makes it difficult to steal the flag 10.

The difficulty of stealing the flag 10 is increased by the design of the additional passage 78 and the slot 80 in the tubular member 48 and by the design of the stiffener 24. Thus, when the margin 14a of the flag 10 is folded around the spine 26 and the flange 28 of the stiffener 24 and the spine 26 and flange 28 are inserted in the additional passage 78 and slot 80, a pull on the flag 10 will cause the margin 14a to tighten around the spine 26 and the flange 28.

Mounting of the flag 10 in the additional passage 78 of the tubular member 48, rather than wrapping the flag 10 around the tubular member 48, allows wear on the flag 10 to be reduced and also reduces the likelihood that the flag 10 will become soiled. Thus, should a golfer or caddie grip the arrangement of the flag 10, the flagpole 32 and the tubular member 48 in the area of the tubular member 48, there will be minimal contact with the flag 10.

Since the flag 10 is slidably mounted on the tubular member 48, the flag 10 can be readily withdrawn from the tubular member 48 after loosening the plug 82 and removing the same from the exposed open end of the additional passage 78. Consequently, the flag 10 can be replaced without replacing the tubular member 48. This enables cost savings to be achieved inasmuch as the tubular member 48 represents a predominant fraction of the cost of the flag mounting arrangement.

It is possible to heat bond the margin 14a of the flag 10 to the stiffener 24. In such an event, the tubular member 48 functions to protect the heat bonded area.

The flagpole 32 can be made of metal while the tubular member 48, the ring 72 and the plug 82 can be made of plastic. With the exception of the jacket 64, the wrench 58 may also be composed of metal.

Various modifications are possible within the meaning and range of equivalence of the appended claims.

1. A flag mounting arrangement comprising:
an elongated supporting member;
a one-piece carrying member designed to hold a flag and to be supported by said supporting member, said carrying member having an external peripheral surface and at least one passage designed to receive said supporting member; and
means for connecting said supporting member to said carrying member, said connecting means including a first connecting element fixed to said carrying member in said at least one passage and a second connecting element for engagement with and disengagement from said supporting member, and said connecting means, said supporting member and said carrying member being designed so that said second connecting element is recessed in said at least one passage at a predetermined location thereof, and both said first connecting element and said second connecting element are incapable of being grasped by human fingers, when said connecting means connects said supporting member to said carrying member

2. A flag mounting arrangement of comprising:
an elongated supporting member;
a one-piece carrying member designed to hold a flag and to be supported by said supporting member, said carrying member having an external peripheral surface and at least one passage designed to receive said supporting member; and
means for connecting said supporting member to said carrying member, said connecting means including a first connecting element in said at least one passage and a second connecting element for engagement with and disengagement from said supporting members and said connecting means, said supporting member and said carrying member being designed so that said second connecting element is recessed in said at least one passage at a predetermined location thereof when said connecting means connects said supporting member to said carrying member, said carrying member having at least one cutout at said predetermined location and said at least one cutout extending from said peripheral surface to said at least one passage to provide access to said second connecting element, said at least one cutout being dimensioned to prevent a human finger from accessing said at least one passage by way of said at least one cutout.

3. The arrangement of claim 2, wherein said carrying member has an additional cutout at said predetermined location directly opposite said at least one cutout, said additional cutout extending from said peripheral surface to said at least one passage, and said additional cutout being dimensioned to prevent a human finger from accessing said at least one passage by way of said additional cutout.

4. The arrangement of claim 2, further comprising an implement designed to enter said at least one cutout and cooperate with said second connecting element so as to permit said second connecting element to be engaged with and disengaged from said supporting member.

5. A flag mounting arrangement of comprising;
an elongated supporting member;
a one-piece carrying member designed to hold a flag and to be supported by said supporting member, said carrying member having an external peripheral surface and at least one passage designed to receive said supporting member; and
means for connecting said supporting member to said carrying member, said connecting means including a first connecting element in said at least one passage and a second connecting element for engagement with and disengagement from said supporting member, and said connecting means, said supporting member and said carrying member being designed so that said second connecting element is recessed in said at least one passage at a predetermined location thereof when said connecting means connects said supporting member to said carrying member said supporting member comprising a main portion with two ends and a threaded portion projecting from one of said ends axially of said supporting member, said supporting member having a shoulder at said one end, and said first connecting element including an abutment for said shoulder, said abutment being fast with said carrying member and defining an opening for passing said threaded portion through said abutment, and said abutment being positioned such that said threaded portion is located inside said passage substantially in its entirety when said threaded portion passes through said opening and said shoulder contacts said abutment, said second connecting element including a nut-like component designed to screw onto said threaded portion.

6. A flag mounting arrangement comprising;
an elongated supporting member;
a one-piece carrying member designed to hold a flag and to be supported by said supporting member, said carrying member having an external peripheral surface and at least one passage designed to receive said supporting member, and said at least one passage having an open end for insertion of said supporting member in said at least one passage;
means for connecting said supporting member to said carrying member, said connecting means including a first connecting element in said at least one passage and a second connecting element for engagement with and disengagement from said supporting member, and said connecting means, said supporting member and said carrying member being designed so that said second connecting element is recessed in said at least one passage at a predetermined location thereof when said connecting means connects said supporting member to said carrying member; and
an insert for placement in said at least one passage in the region of said open end, said insert being provided with an opening for said supporting member and being designed to inhibit direct contact between said carrying member and said supporting member.

7. The arrangement of claim 6, wherein said at least one passage is provided with at least one rib in the region of said open end to fix said insert in said at least one passage.

8. The arrangement of claim 6, wherein said at least one passage is provided with a seat for said insert in the region of said open end.

9. The arrangement of claim 1, wherein
said carrying member has a first passage designed to receive said supporting member and a second passage for holding a flag.

10. The arrangement of claim 9, wherein said carrying member has a slot-like opening between said second passage and said external peripheral surface.

11. The arrangement of claim 10 further comprising a carrier for a flag, said carrier comprising an elongated component receivable in said second passage and a flange on said elongated component receivable in said slot-like opening.

12. The arrangement of claim 9, wherein said second passage has an open end; and further comprising a plug for said open end.

13. The arrangement of claim 1, wherein said flag includes a layer of polyvinylchloride.

14. The arrangement of claim 1, wherein
said flag is provided with a laser-printed image.

15. The arrangement of claim 13, wherein said flag comprises an additional layer of polyester.

16-22. (canceled)

23. The arrangement of claim 2, wherein said carrying member has a first passage designed to receive said support member and a second passage for holding a flag.

24. The arrangement of claim 23, wherein said carrying member has a slot-like opening between said second passage and said external peripheral surface.

25. The arrangement of claim 24, further comprising a carrier for a flag, said carrier comprising an elongated component receivable in said second passage and a flange on said elongated component receivable in said slot-like opening.

26. The arrangement of claim 23, wherein said second passage has an open end; and further comprising a plug for said open end.

27. The arrangement of claim 2, wherein said flag includes a layer of polyvinylchloride.

28. The arrangement of claim 1, wherein said flag is provided with a laser-printed image.

29. The arrangement of claim 27, wherein said flag comprises an additional layer of polyester.

30. A flag mounting arrangement comprising:
an elongated supporting member;
a carrying member designed to hold a flag and to be supported by said supporting member, said carrying member having an external peripheral surface and at least one passage designed to receive said supporting member; and
means for connecting said supporting member to said carrying member, said connecting means including a first connecting element in said at least one passage and a second connecting element for engagement with and disengagement from said supporting member, and said connecting means, said supporting member and said carrying member being designed so that said second connecting element is recessed in said at least one passage at a predetermined location thereof when said connecting means connects said supporting member to said carrying member and so that said supporting member is releasable from said carrying member only with a mechanical implement adapted to engage one of said connecting elements in said at least one passage.
